(19) United States
(12) Patent Application Publication
(10) Pub. No.: US 2010/0071017 A1
(43) Pub. Date: Mar. 18, 2010

(54) Distributing video assets

(76) Inventor: Michael Lawrence Woodley, Cambridge (GB)

Correspondence Address: JAMES C. WRAY, 1493 CHAIN BRIDGE ROAD, SUITE 300, MCLEAN, VA, 22101, US

(21) Appl. No.: 12/283,709

(22) Filed: Sep. 15, 2008

(51) Int. Cl. H04N 7/173

(52) U.S. Cl. 725/115; 725/105; 715/719

(57) ABSTRACT

Video assets (501) are distributed to browsing clients (106) to (108) from a server (104). Source video clips are received from an originator (101) and assembled into a contiguous video asset. The contiguous video asset is divided into asset portions of substantially similar length and an example video frame (502) to (516) is selected for each of the asset portions. A web page 106 is created that is accessible to the browsing client and includes an array of the example video frames with a link to their respective asset portion.

### TECHNICAL FIELD

The present invention relates to distributing video assets to browsing clients.

### BACKGROUND OF THE INVENTION

For many years, amateur enthusiasts have created recordings on cinematographic film, analog digital tape, digital video tape and more recently by other means of digital data storage. Collectively, material of this type may be referred to as “home videos”, some of which may be highly prized and other examples of which may never see the light of day.

Many techniques and facilities exist for assisting with the editing of home movie material and it is well acknowledged that much of the material produced is of limited value until an editing operation has been performed. However, more often than not, a recordist does not wish to engage in editing activities and the objective never becomes realised, unless it is being done for a special occasion, (such as a wedding) or on a semi-professional basis.

A problem therefore exists in terms of enhancing the availability and distribution of home videos, primarily within circles of people having an interest in the content. Thus, it is desirable for the material to become available and interesting to people within the circle, without placing an unnecessary burden upon the original producer of the material.

### BRIEF SUMMARY OF THE INVENTION

According to an aspect of the present invention, there is provided a method of distributing video assets to browsing clients. Source video clips are received from an originator and are assembled into a contiguous video asset. The video asset is divided into asset portions of substantially similar length. An example video frame is selected for each of the asset portions and a page is created that is accessible to browsing clients that includes an array of the example video frames with a link to their respective asset portion.

### BRIEF DESCRIPTION OF THE SEVERAL VIEWS OF THE DRAWINGS

FIG. 1 shows an environment for the distribution of video assets to browsing clients;

FIG. 2 shows a protocol diagram illustrating the relationship between entities identified in FIG. 1;

FIG. 3 shows an example of a platform for the video source identified in FIG. 1;

FIG. 4 illustrates examples of source material;

FIG. 5 illustrates the processing of video data;

FIG. 6 details the server identified in FIG. 1;

FIG. 7 illustrates operations performed by the video source identified in FIG. 1;

FIG. 8 illustrates the selection of an example frame;

FIG. 9 illustrates a table of guests;

FIG. 10 illustrates a table of categories;

FIG. 11 illustrates a table of video assets;

FIG. 12 illustrates a table that defines rankings within a category;

FIG. 13 illustrates an interface for the mapping of user groups to categories;

FIG. 14 illustrates a table for the identification of tabs;

FIG. 15 illustrates a display of example frames; and

FIG. 16 illustrates the display of downloaded video material.

### DESCRIPTION OF A BEST MODE FOR CARRYING OUT THE INVENTION

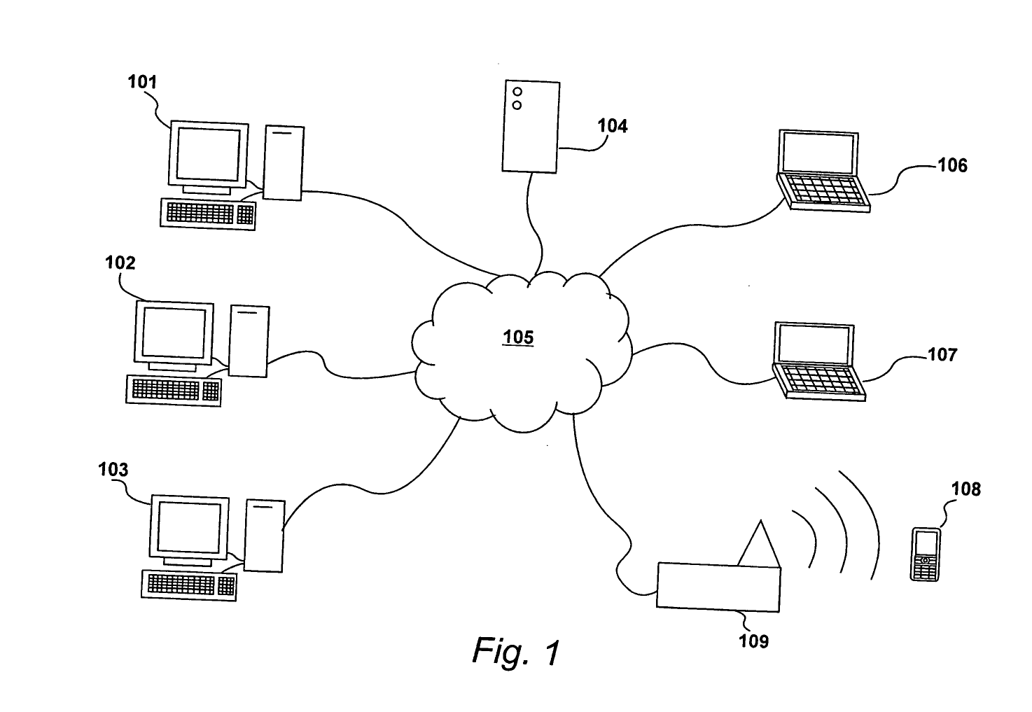

### FIG. 1

An environment for the distribution of video assets to browsing clients is illustrated in FIG. 1. The environment includes video sources 101, 102, 103 along with a server 104 each connected to a network 105. The environment also includes video browsers 106, 107 and 108, browser 108 being in the form of a mobile cellular telephone connected to network 105 via a radio telephony network 109.

The server 104 is arranged to receive video clips from the video sources 101 to 103 and make this video material available to browsers 106 to 108. The material is also available to the originators 101 to 103 and modifications may be made and further data may be received in order to enhance the experience of browsing the video material.

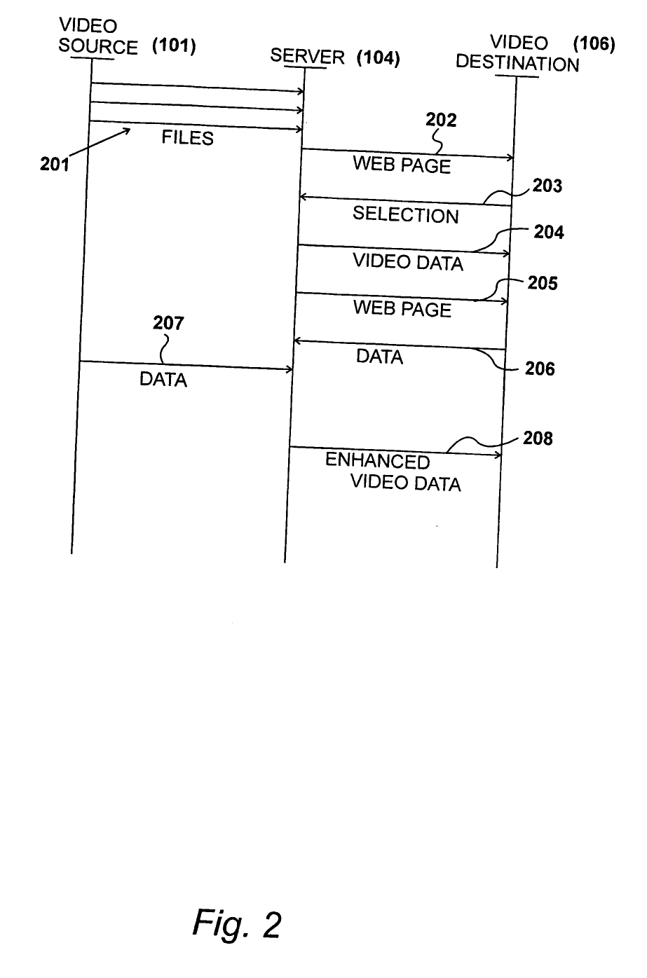

### FIG. 2

A protocol diagram is shown in FIG. 2, illustrating the relationship between a typical video source, the server 104 and a typical browsing client 106.

Data files 201 are uploaded to server 104 from a video source (101). These files may take many forms and it may be necessary for the source 101 to perform a degree of pre-processing or for a degree of pre-processing to be performed elsewhere prior to the upload operation being performed.

At the server 104 the video material is processed in accordance with a preferred aspect of the present invention, in which source clips are assembled into a contiguous video asset. Furthermore, the video asset is divided into a plurality of asset portions. An example video frame is selected for each asset portion and a web page is generated that includes an array of the example video frames. Thus, as illustrated at 202, a web page is served from server 104 to the video destination 106. The web page displays an array of example video frames and from this, via a link, a selection is made as illustrated at 203.

Having made the selection at 203, the video data is supplied as illustrated at 204. In a preferred embodiment, the supply of video data is achieved by a streaming operation although in an alternative embodiment it would be possible for the whole file to be downloaded.

Having viewed the video data, a new page, such as a web page, is displayed as illustrated at 205.

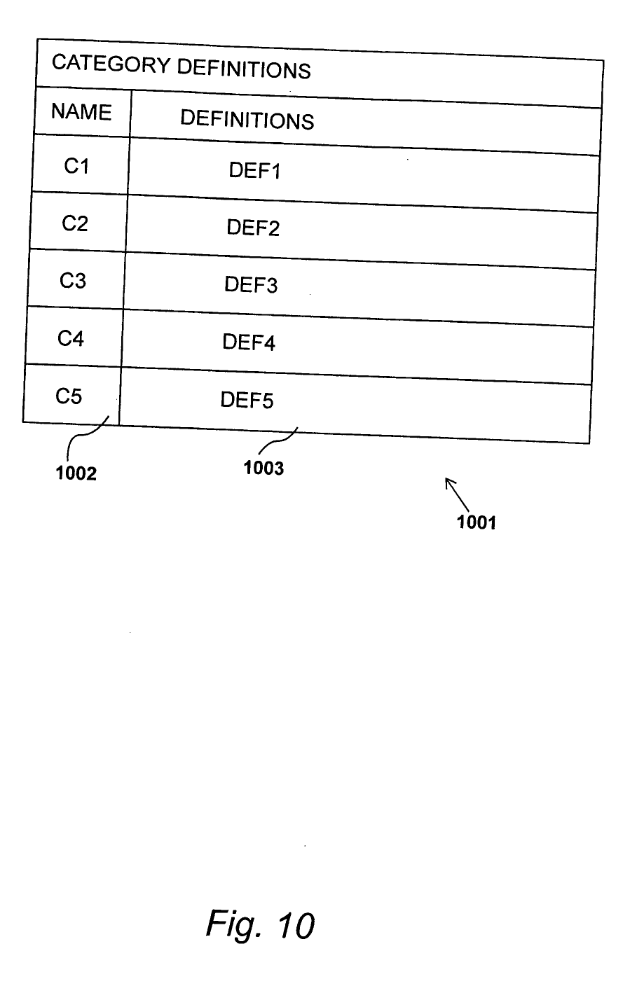

In response to this page being displayed, further data may be uploaded to the server as illustrated at 206. Furthermore, additional data may be received from the video source 101 as shown at 207. Thus, it is now possible for enhanced video data to be received at the video destination 106, as illustrated at 208. In a preferred embodiment, a channel is displayed to a browser 106 that has a fixed dimension pop-up window with no window controls. Preferably, the window is designed to be displayed on a high definition television set and the channel is brought up when a guest logs in. Thus, this may be considered as a personal Internet video channel with a specialised menu system for accessing content. The establishment of guests will be described subsequently with reference to FIG. 10.

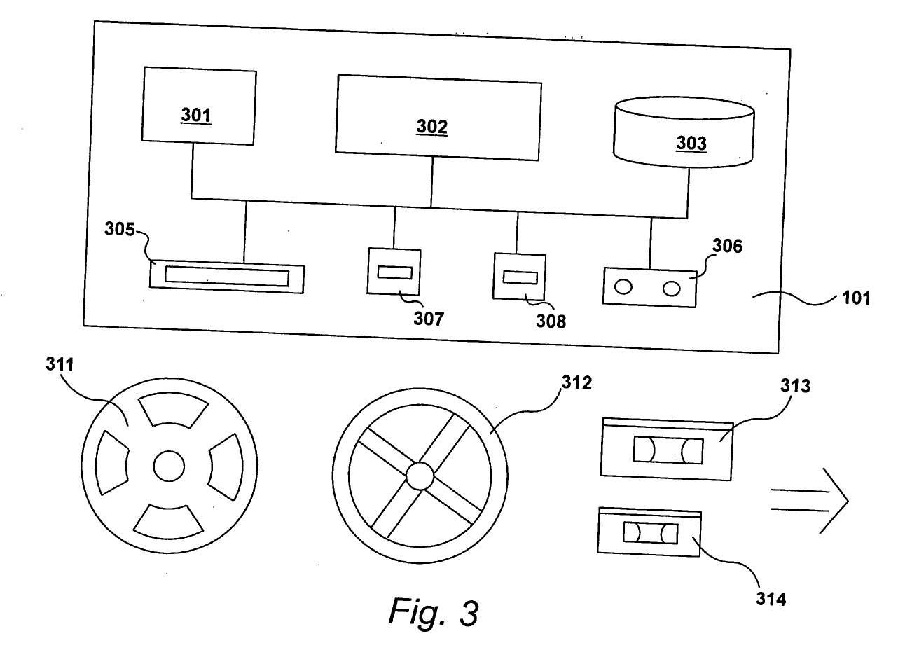

### FIG. 3

An example of a platform for video source 101 is identified in FIG. 3. The platform includes a programmable processor 301, randomly accessible memory devices 302 and a hard disc storage device 303 each connected to a system bus 304. The system bus also communicates with a DVD player 305 and a serial interface 306 for communicating with peripheral devices such as a mouse and a keyboard. The system also includes a data transfer interface such as a USB interface 307 and a high definition television interface 308.

Video material may be received from a recorded DVD via the DVD player 305. Video data may also be received by interface 307 (as a data file) or via television interface 308 as a digital video signal. It is also appreciated that legacy material may exist in the form of analog magnetic tape 311, cinematographic film 312, analog video cassettes 313 and digital video cassettes 314.

In a preferred embodiment, digital data received directly are modified into a native format, possibly using an H264 CODECs. The procedure also pulls out a still frame every 20 seconds and writes the results to a folder of stills plus the video asset. A packet based loading procedure to the server 104 (preferably an FPT server) is then performed. Thus, in a preferred embodiment a conversion into a preferred native format is performed at the video source platform 101 prior to being uploaded to the server 104. In this way, processing requirements of the server 104 are reduced significantly.

In a preferred embodiment, each user is provided with an uploader which is an installed program that launches on the desktop and then waits for the arrival of video material. If multiple clips of video are sent together, the system will splice them into a single movie. Files could therefore be uploaded via a DVD recorder and then concatenated into one movie. Thus, in a preferred embodiment, the concatenation process also occurs at the video source 101 after individual files have been directed towards the uploader on receiving video.

For legacy material 311 to 314 it would be possible to provide a media conversion service. Software downloaded to the video source 101 (or received via a data carrying medium) assists with the provision of this service. Thus, the video source 101 is configured to assist with the calculation of the size of the media so that appropriate packaging can be sent out with pre-addressing. The media is then sent to a bureau which confirms that they have received the material and performs a conversion process to a digital master of high quality, possibly using MPEG 2. This is then sent on to the server 104.

At the server 104 a batch of such material is received which is converted to a streamable format and stored with reference to the appropriate account. The original media is preferably sent back to the user (preferably using the same packaging) and an alert is raised to the effect that the material is now ready to be viewed. The DVD master set can also be sent on as an extra in the post, in response to a selection being made to this effect when the order is placed on line.

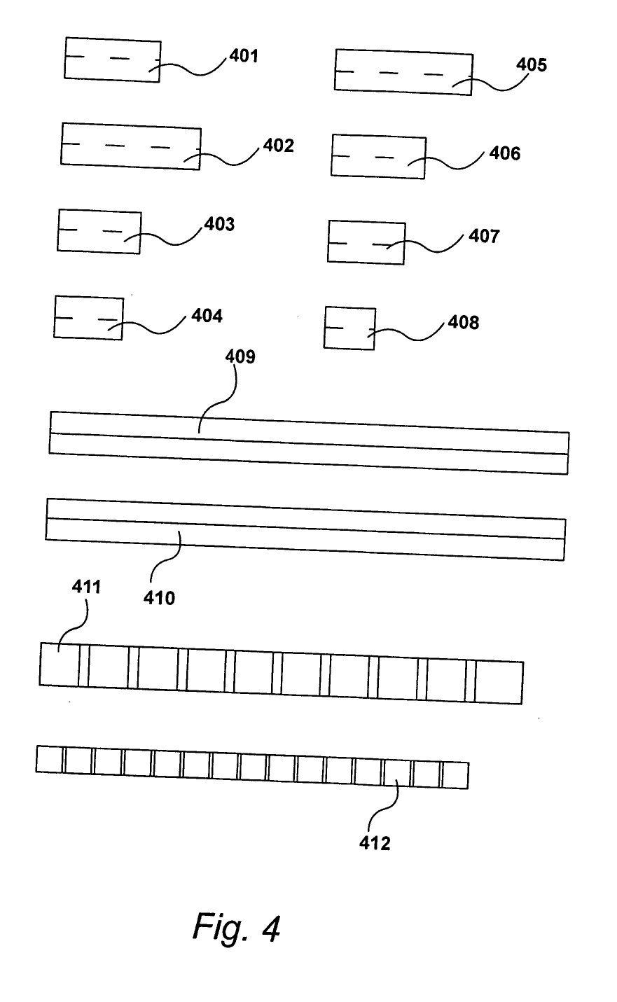

### FIG. 4

Examples of source material are illustrated in FIG. 4. These include individual digital video files. Source material may also include domestic analog video material (VHS or S-VHS for example) along with higher quality semi-professional analog video tape 410, such as U-matic video tape. (The example also illustrates commercial cinematographic film 411 (35 mm for example) along with amateur cinematographic material 412, such as 8 mm film.

In order to upload this material, it is possible for digital files 401 to 408 to be selected locally and converted locally so that a collection of video material and image frames may be uploaded to the server 104.

In order to modify analog video sources 409 and 410, the preferable approach may be to replay the material using its original equipment and thereafter digitising the analog video output by means of a DVD recorder or similar device. Unless a user has access to a film scanner, it is likely that the cinematographic film material 411, 412 will be sent to the conversion bureau as previously described.

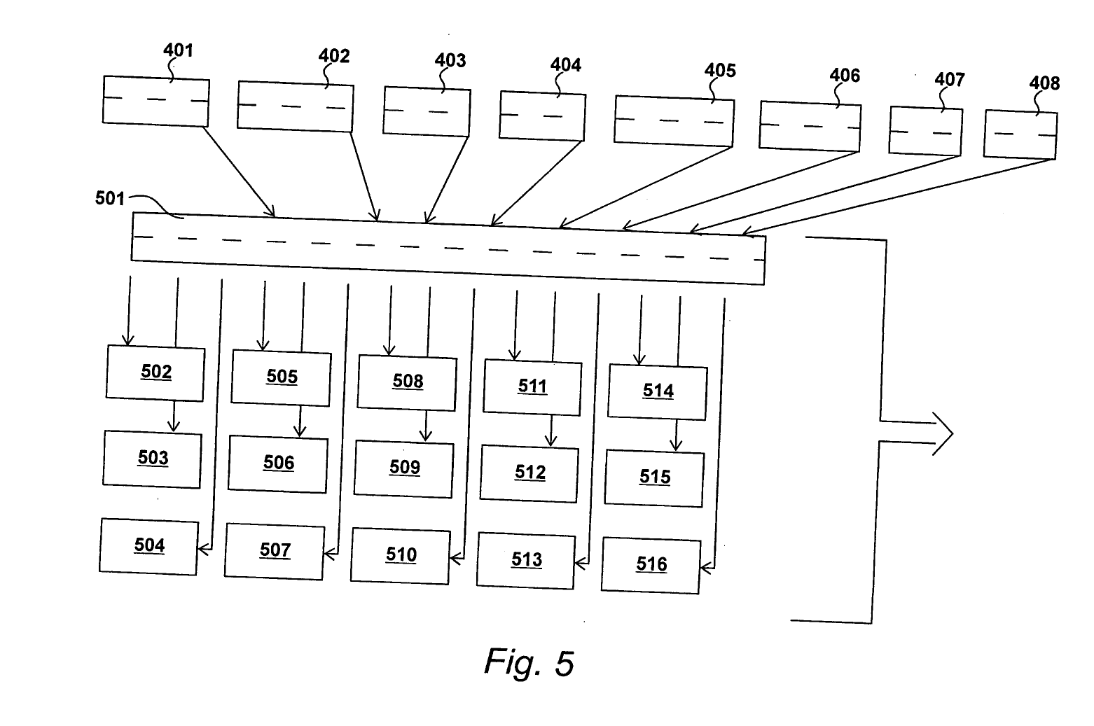

### FIG. 5

In this example, individual files 401 to 408 have been selected and presented to the uploader software as a unified video asset. These video files may have been created by a digital video recorder and encoded in a compressed format, such as MPEG 4. A plurality of files have been produced because each time a stop operation is effected during the recording process, a new file is encoded and written to local storage, possibly taking the form of a miniature disc drive or a solid state storage device. On such equipment, the frames are usually named using a consecutive numbering sequence therefore the correct sequence of the files is readily identified. Thus, having received files 401 to 408 as a group of independent data sources, the launcher first orders these into the correct sequence, making reference to the numbering system used during file creation. Thus, the files are shown in order in FIG. 5 as 401 to 408.

Each individual file 401 to 408 is self contained and will often include header information specifying how the material is to be processed by an appropriate CODEC. Thus, it is not generally possible to simply concatenate the files to produce a single file without first performing a degree of decoding. Thus, having decoded the material it is then possible to produce a contiguous file 501 in a preferred native format, having firstly downloaded CODEC procedures so that an appropriate decoding operation may be performed on each of the individual files, followed by a concatenation process to produce a contiguous video file which is then re-coded.

Prior to the re-coding process, individual image frames are read and stored as image thumbnails by effectively dividing the video asset into a plurality of asset portions. Thus, an example video frame is selected from each of the asset portions which at this initial stage, in a preferred embodiment, results in a thumbnail image being recorded that is derived from the frame present at the start of each twenty second portion.

In this example, fifteen image frames have been derived, representing a video clip of five minutes duration. Thus the start of the video clip 501 may be considered as having a time code of 00:00:00 and a thumbnail 502 is generated from the image frame present at this time code location. The start of the next twenty second portion will be identified by time code 00:20:00 and again a frame is read at this location and down converted to thumbnail 503. Similarly, the next location will be 00:40:00 resulting in the storage of thumbnail 504 and so on until all of the thumbnails to thumbnail 516 have been generated and recorded. Having done this, it is now possible for the entire folder consisting of the video file 501 and image thumbnails 502 to 506 to be uploaded to the server 104.

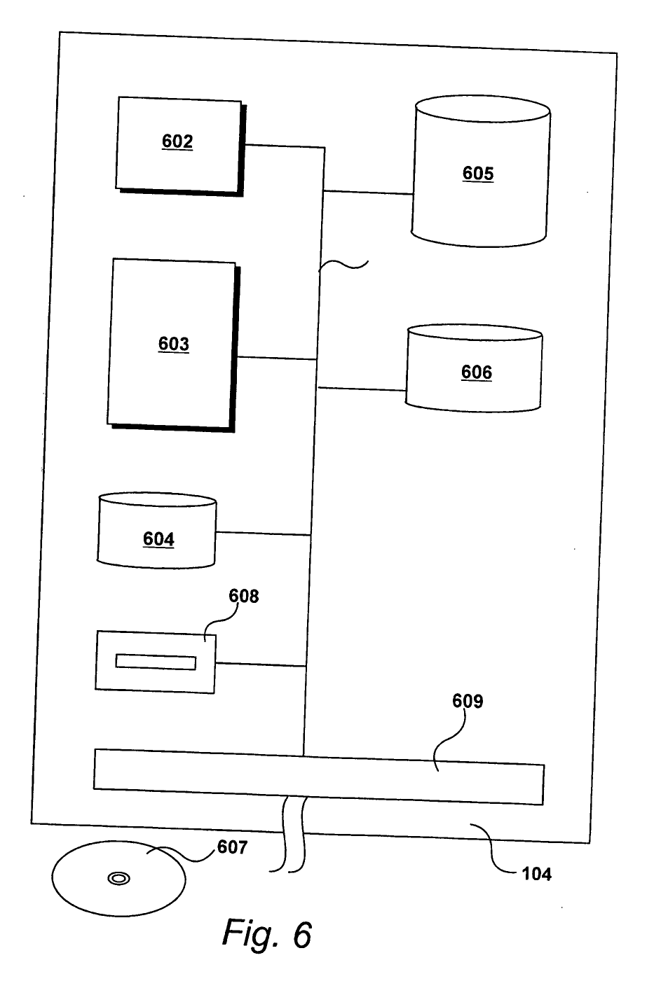

### FIG. 6

Server 104 is detailed in FIG. 6. A system bus 601 provides communication between a processor 602 and random access memory devices 603. In this example, the server 104 is also provided with three permanent storage devices implemented as disc drives 604, 605 and 606. Program instructions may be received from a data carrying medium 607, such as a DVD, via a DVD reader 608. Furthermore, communication over network 105 is facilitated by the provision of a network interface 609.

Storage device 604 is primarily provided for the storing of installed program instructions and temporary data files.

Relatively large storage device 605 is provided for the storage of video and image data received from users. This data is overseen by a database and additional data is written to said database to enhance the provision of the recorded material. Thus, in this embodiment, the database is retained on disc storage device 606.

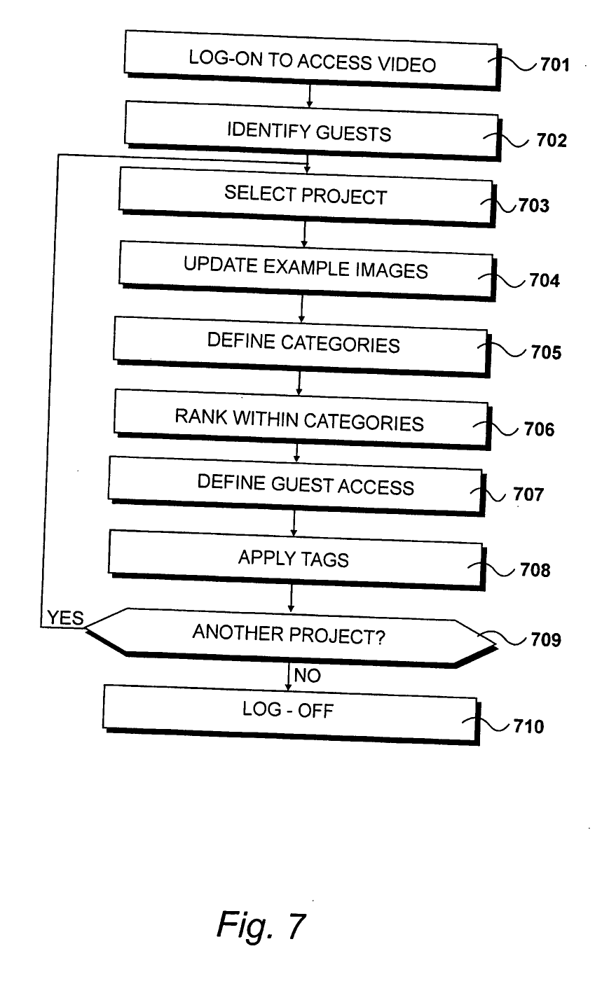

### FIG. 7

Operations performed by the video source 101 when interacting with the server 104 are illustrated in FIG. 7.

At step 701 a user logs onto the database in order to access video material and upload further video material.

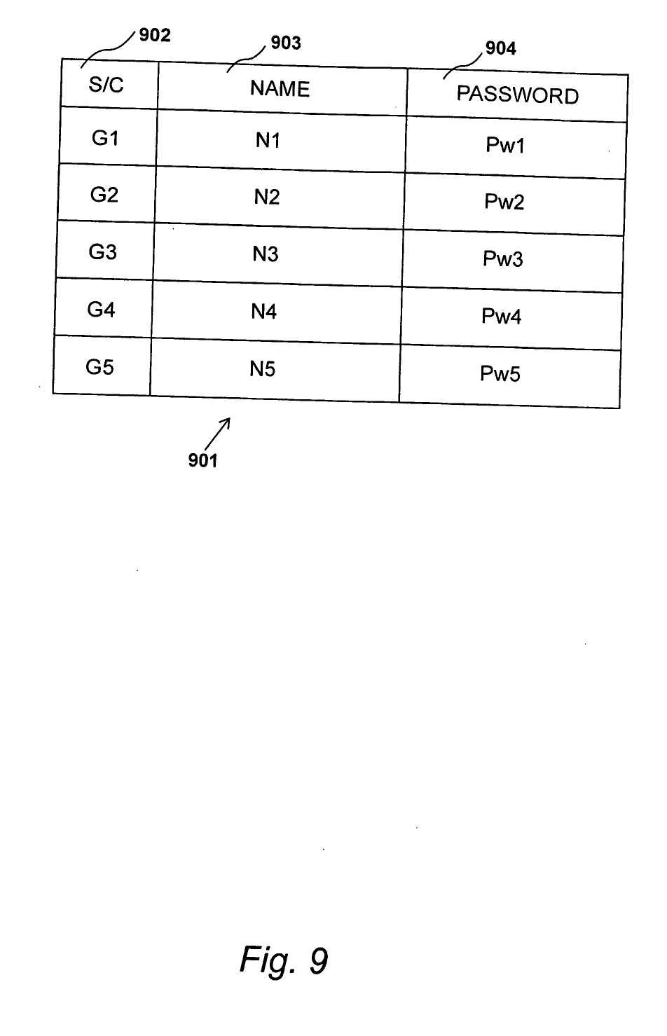

At step 702 a user may identify guests who effectively have enhanced access rights and are described in greater detail with reference to FIG. 9.

At step 703 a project is selected and at step 704 an update operation is performed, as described previously with respect to FIG. 5.

At step 705 it is possible for a user to define categories and at step 706 when viewing a particular category it is possible to organise video assets in a preferred rank or order.

At step 707 guest access provisions are defined and at step 708 it is possible for individual frames or assets to be tagged. At step 709 a question is asked as to whether another project is to be considered and when answered in the affirmative, a further project may be selected at step 703. Alternatively, a log-off condition occurs at step 710.

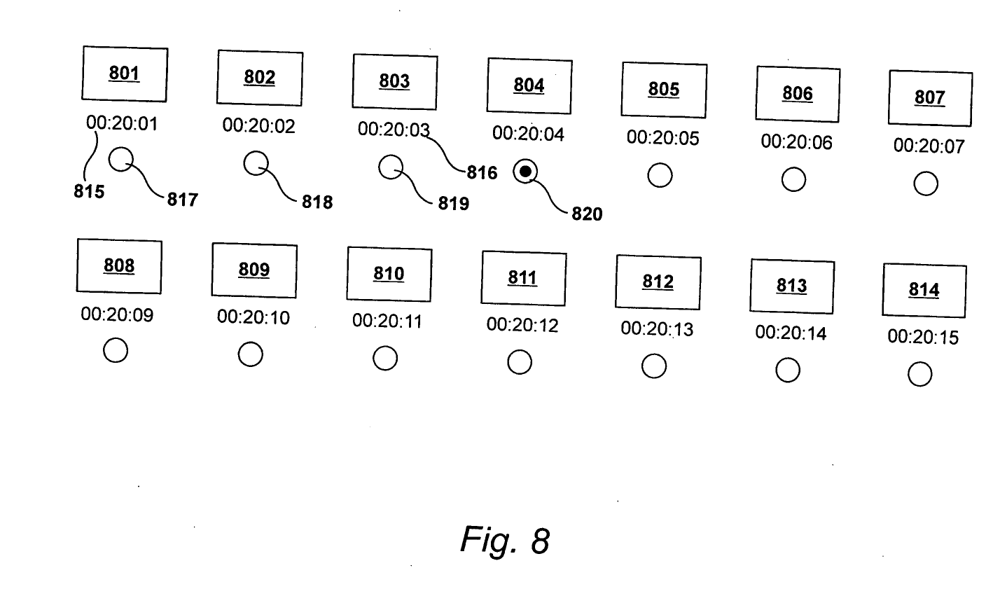

### FIG. 8

As described with respect to FIG. 5, the video asset is divided into asset portions of substantially similar length, this length being pre-specified in the preferred embodiment at twenty seconds. In addition, an example frame is selected for each of the asset portions such that these thumbnail images may be displayed in a web page that is accessible to the browsing clients and includes links to the asset portions. By default, the example frame for each portion is the first frame of that portion. However, within a twenty second clip, it is possible that another frame may be more representative of the material contained within the portion. Thus, as identified at step 704, it is possible to update the example images.

As illustrated in FIG. 8, upon selecting the update option, with respect to a particular video portion, individual frames of that portion are displayed to the user. In the example shown in FIG. 8, fourteen frames are shown for a portion that starts at time code 00:20:01 and referenced 801 to 814. The actual time code for each image is displayed below the image. Thus, at 815 the time code is identified as 00:20:01. Similarly, at 816 the time code has incremented by one frame and is therefore represented as 00:20:02. The actual number of frames contained within the portion will depend upon the actual video standard being used and typically consists of twenty-four frames, twenty-five frames, twenty-nine frames or thirty frames per second. Original source material may have been recorded in an interlaced fashion with odd and even fields making up each frame. In a preferred embodiment, material of this type is converted into a progressive video format and each image frame represents a full bandwidth image.

Below each combination of an image frame and its time code, there is also a radio button, such as button 817 for frame 801, button 818 for frame 802, button 819 for frame 813 and button 820 for frame 804 etc. Selection of a particular radio button, by mousing over and clicking, results in a particular frame being selected and the previously selected frame being deselected. By default, frame 801 will have been selected as the example frame, given that this represents the first image frame of the portion. However, for the purposes of illustration, a user as identified frame 804 as being more appropriate and therefore radio button 820 has been selected (as shown in FIG. 8) thereby deselecting button 817. Consequently, when viewed as an array of thumbnails representing the whole of the video clip, the particular portion from time code position 00:20:01 will be identified by a thumbnail derived from image frame 804 instead of being derived from image frame 801.

### FIG. 9

It can be seen from the above that a point has now been reached where the video material has been divided into portions with a thumbnail image being used to identify each portion within the clip. Furthermore, where appropriate, alternative image frames may have been selected as the representative example for the portion. The material is therefore ready to be made available to other users of the system. At the server, these video assets are held in storage device 605, possibly taking the form of a redundant array so as to minimise the risk of data being lost. A relational database is held in storage device 606 including a plurality of tables upon which queries may be enacted so as to provide an enhanced video viewing experience, as suggested by 208.

As previously described, step 702 provides for the identification of guests, who my be identified as other users, say users 107 and 108 who have privileged access to the stored material.

Table 901 stores details of guests. Thus, at column 902 a short code identifies the existence of a guest, shown in the example as G1, G2, G3, G4, G5. In column 903, for each short code there is identified the name of the guest and at column 904 the guest is required to be identified with a password. Thus, in a preferred embodiment, it is possible to define up to five guest groups. Each guest group only has access to the assets where access has been granted and the guest does not have access to anything further. Thus, typical guest groups would include related families where video material of common interest could be shared and combined etc. Separate guest groups could also be established for the paternal and maternal sides of a family. A further example of a guest group would be that relating to a particular hobby or activity where members participating in the activity would again allow the material to be shared.

### FIG. 10

It is also appreciated that particular video assets could be of interest to some members of a group, where it would not be appropriate to provide access to other members of a group. However, it is possible that some assets may exist where it would be appropriate to show the material to both groups. Thus, a shared activity could also be of interest to other members of the family for example. FIG. 10 shows an additional table 101 where it is possible to define categories, as identified at step 705. Thus, the first column 1002 provides a category name, illustrated as C1, C2 etc in this example, each followed by a definition in a column 1003, identified as DEF1, DEF2, DEF3 etc in this example.

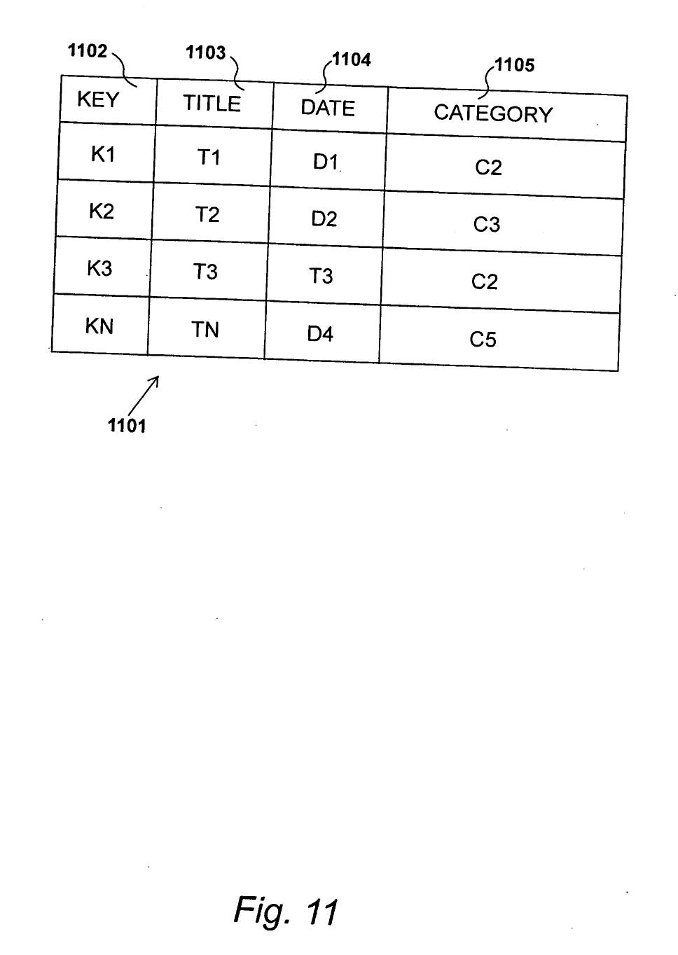

### FIG. 11

The database makes provision for each video clip to be identified from storage device 605. In addition, the database also provides for the storage of metadata associated with each video clip, as illustrated in FIG. 11. Table 1101 includes a first column 1102 which may be considered as a key to the particular clip under consideration. This would be associated with a pointer to storage device 605. In addition, column 1203 allows for a title to be stored and column 1204 allows the production date to be stored. Furthermore, categories may be defined in a column 1205. Thus, in this example, title T1 has been placed in category C2, title T2 has been placed in category C3 and title T3 has been placed in category C2. It is possible to select a categories option that shows all of the categories plus an additional trash category. The ranking of assets within the categories can be changed which changes the order in which they appear in a displayed channel menu. Thus, it is possible to see how many assets are present in each category and which of the guest groups have access to that category.

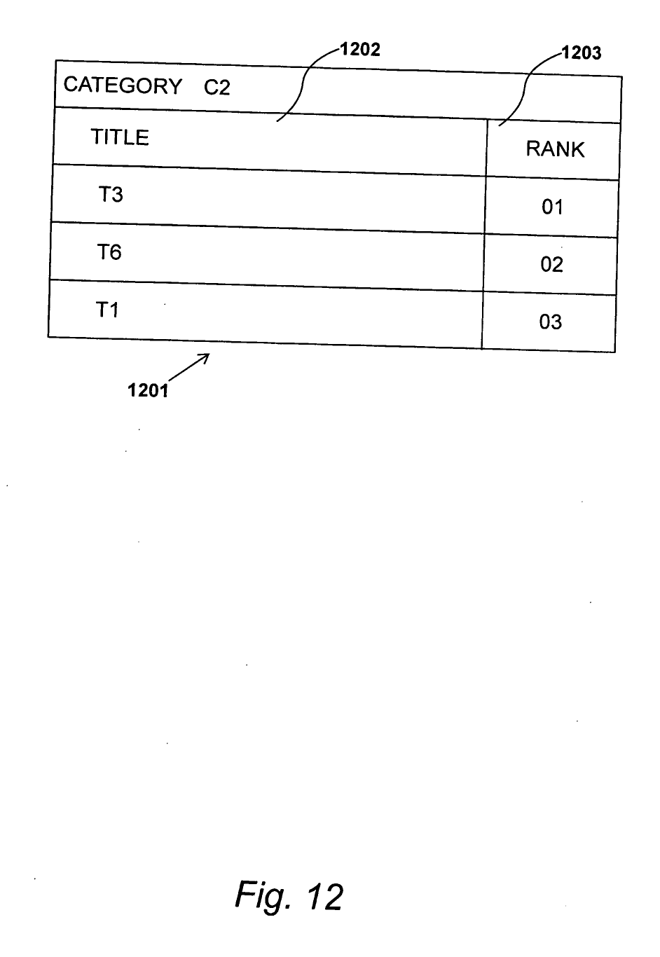

### FIG. 12

A table 1201 for the ranking of titles within a particular category is illustrated in FIG. 12. A first column 1202 identifies titles and a second column 1203 defines an ordered ranking. Thus, in this example, titles T1, T3 and T6 have been identified as belonging to category C2. However, title T3 is considered by the user to be the best example of a title within this category, followed by title T2 and then by title T1.

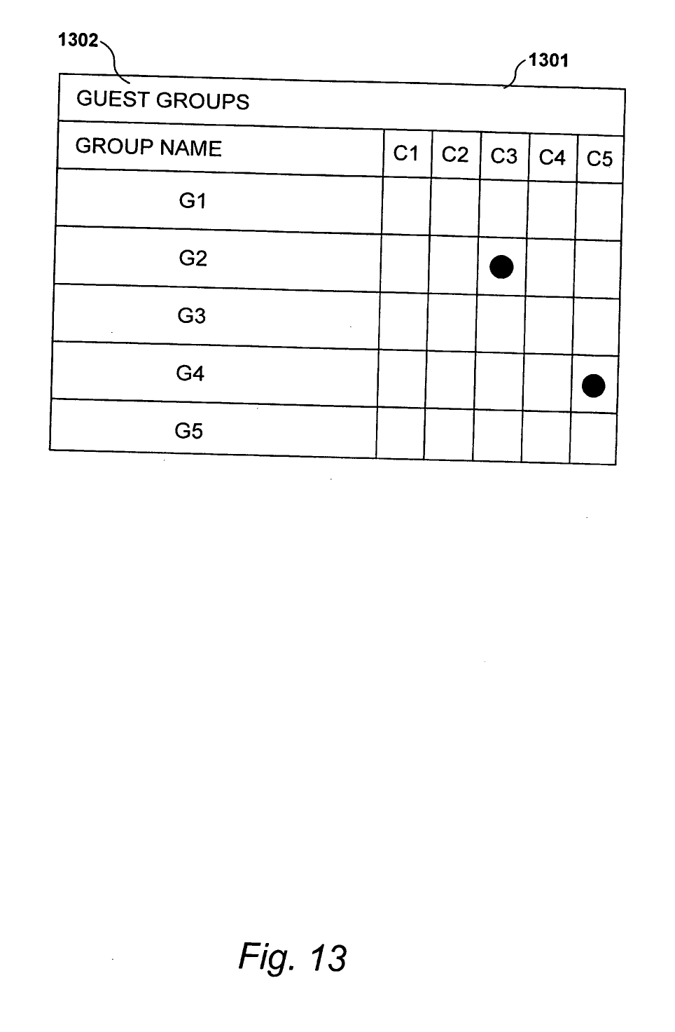

### FIG. 13

It is generally envisaged that particular groups would be given access to particular categories. Thus, an interface 1301 illustrated in FIG. 13 shows how this mapping may be defined.

A column 1302 identifies each of the available groups, up to a total of five in the preferred embodiment. For each group a further column is provided for each of the available categories. The system does not place an upper limit on the umber of categories available but for the purposes of illustration, the interface shows categories C1, C2, C3, C4 and C5. A category may be selected by mousing over an appropriate matrix location and clicking. Thus, by performing this operation, group G2 has been given access to all assets in category C3 and group C4 has been access to all assets in category C5.

Although a default situation exists to the effect that the whole of the category is made available to a particular guest group, it is possible to identify a particular asset as being private, while it remains in a potentially shared category. Thus, if an asset identified as being appropriate to category C3 is also identified as being a private asset, guest group G2 will see the remaining assets categorised as C3 but group G2 will not see the particular asset that has been identified as being private.

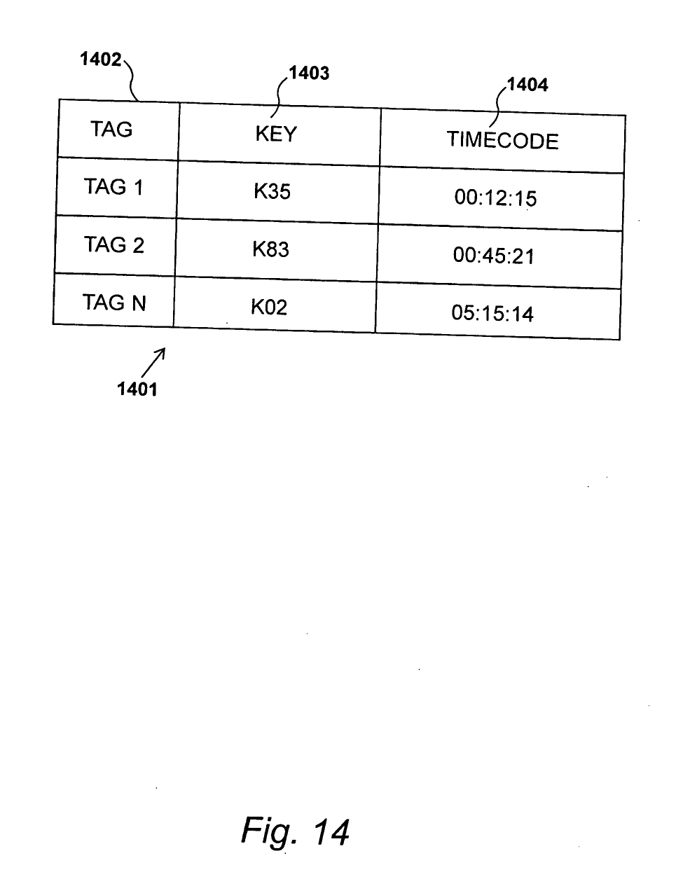

### FIG. 14

Searching for particular video assets is also facilitated by the inclusion of tags. In a user interface, a “tag” button is provided which when operated identifies the particular time code of the asset being viewed and then presents a text box to the user. In this way, it is possible for a particular scene or clip to be described. It is then possible to search using this term, whereafter the search results are displayed and individualised items clicked in order to play the appropriately tagged asset.

The inclusion of more tags allows rich searching to be performed and in a preferred embodiment a dictionary is provided which is updated when new terms are added in a tag. In an embodiment, tags are stored in a database table 1401.

In table 1401, a first column 1402 identifies the tag name, shown as tag 1, tag 2 etc to tag N in this example. The particular video asset under consideration is identified by its key, this being equivalent to column 1202 in FIG. 11. Thus, a first tag is identified for asset key K35, a second for asset key K83 and in this example the nth is identified for asset key K02?

Having defined the tag and identified the particular asset or clip under consideration, a duration or position within the asset is identified in column 1404 by identifying the particular time code of the frame being displayed when the create tag button was activated.

Originators at video sources 101 to 103 are provided with the facility to add and remove tags. In a first embodiment, viewers 106 to 108 are allowed to add and modify tags in the same way as originators. However, in alternative embodiments users may not be provided with this facility or they may be provided with a restricted facility, such that they are allowed to create tags but not allowed to remove them.

As previously described, each user creates a database of content which is effectively done with respect to their own account. Each tag will be associate with the content and then depending upon guest permissions, each will have access to the video asset database of others, with searching being facilitated by the use of tags. Thus, in this way, it is possible to organise a search across a shared archive.

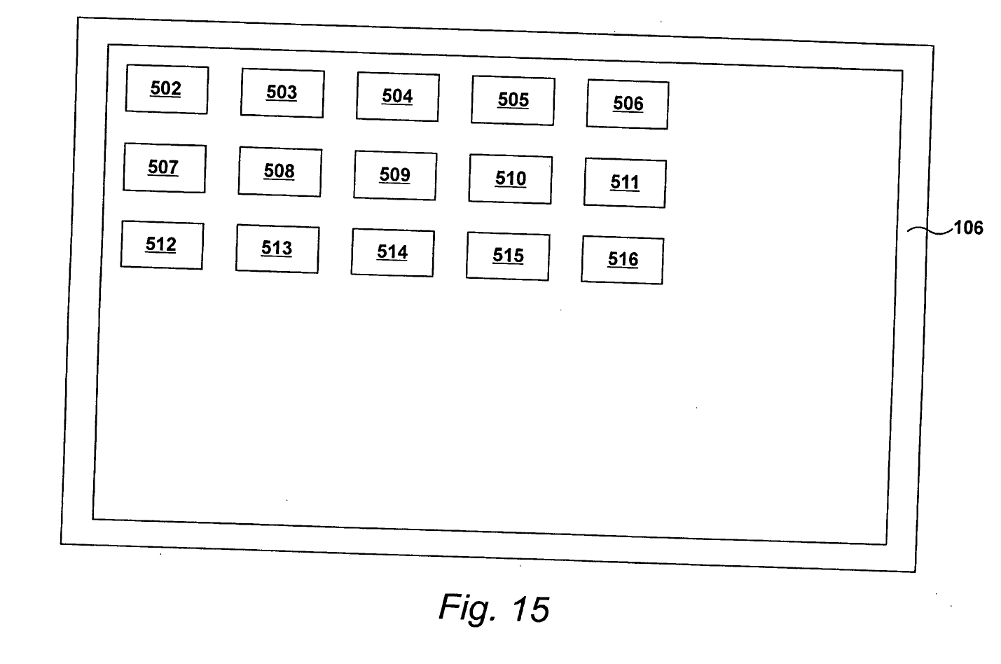

### FIG. 15

The display of a matrix of example frames on viewer device 106 is illustrated in FIG. 15. The thumbnail images represent those described with reference to FIG. 5. Thus, a viewer is presented with a matrix of fifteen thumbnails, each being an example of a twenty second portion of a contiguous video clip. In this way, it is possible for a particular portion to be selected and the portion, or the entire clip, viewed.

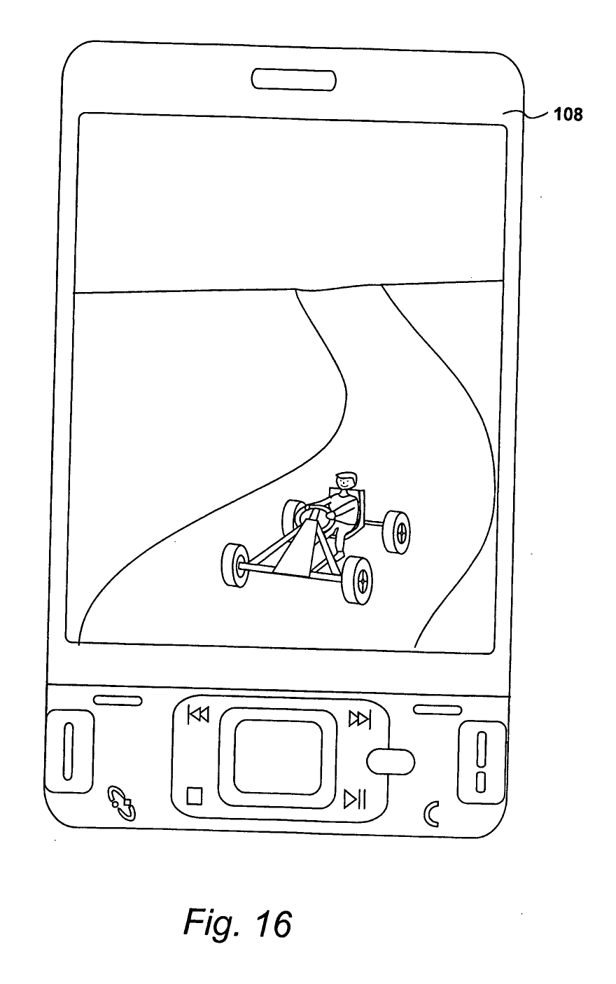

### FIG. 16

It is also possible for a channel to be supplied to a mobile device, such as device 108. Again, when displayed on a mobile device, this may be considered as a personal Internet video channel with a specialized menu system to access content.

What I claim is:

1. A method of distributing video assets to browsing clients, comprising the steps of:
receiving a plurality of source video clips from an originator;
assembling said source clips into a contiguous video asset;
dividing said video asset into a plurality of asset portions of substantially similar length;
selecting an example video frame from each of said asset portions; and
creating a page that is accessible to said browsing clients that includes an array of said example video frames with a link to their respective asset portion.

2. The method as claimed in claim 1, wherein each said source clip is a machine-readable file of compressed video data.

3. The method of claim 2, wherein each said machine-readable file is an MPEG 4 file.

4. The method as claimed in claim 2, wherein said source clips are decoded, combined into said contiguous asset and re-coded.

5. The method as claimed in claim 1, wherein said selecting step selects the first frame from each asset portion as the example video frame.

6. The method as claimed in claim 1, wherein said selecting step shows an asset portion as contiguous frames and a graphical user interface invites input data from a user so as to select a particular one of said displayed frames as the example video frame.

7. The method as claimed in claim 1, including a database for storing data identifying video sources and additional data supplied by said video sources.

8. The method as claimed in claim 1, wherein said additional data includes an identification of guests and details of video assets for which said guests are to be given access.

9. The method as claimed in claim 1, wherein said additional data includes an identification of categories for said video assets.

10. The method as claimed in claim 9, wherein an originator is provided with a graphical user interface for specifying a ranking of assets within each said category.

11. The method as claimed in claim 1, wherein said additional data includes an identification of tags for each said asset portion.

12. The method as claimed in claim 11, wherein an originator is provided with a graphical user interface for specifying tags for said asset portions.

13. The method as claimed in claim 11, wherein browsing clients are provided with a graphical user interface for specifying tags for said asset portions.

14. The method as claimed in claim 11, including the steps of receiving one or more tags as search terms, performing a search across a plurality of sources and supplying a display of example frames from a plurality of sources that satisfy the search criteria.

15. Apparatus for distributing video assets to browsing clients, comprising:
a plurality of video sources;
a server including storage devices for video assets and a database; and
a plurality of video browsers; wherein, said server is configured to:
receive a plurality of source video clips from a video source;
assemble said source clips into a contiguous video asset;
divide said video asset into a plurality of asset portions;
select an example video frame from each said asset portion; and
serve a web page to a video browser that includes an array of said example video frames with a link to their respective asset portion.

16. The apparatus as claimed in claim 15, wherein said database stores data identifying video sources and additional data supplied by said video sources.

17. The apparatus as claimed in claim 15, wherein the additional data stored on said database includes an identification of guests along with details of video assets for which said guests are to be given access.

18. A computer-readable medium having computer-readable instructions executable by a computer such that, when executing said instructions, a computer will perform the steps of:
receive a plurality of source video clips;
assemble said source video clips into a contiguous video asset;
divide said video asset into a plurality of asset portions of substantially similar length;
select an example video frame from each of said asset portions; and
upload said video asset and said video frames to a serving device.

19. The computer-readable medium as claimed in 18, such that, when executing said instructions, said computer will decode said source clips, combine decoded clips into a contiguous asset and re-code said contiguous asset.

20. A computer-readable medium as claimed in claim 18, such that, when executing said instructions, said computer will select the first frame of each asset portion as the example video frame.
